(19) United States
(12) Patent Application Publication
(10) Pub. No.: US 2026/0267324 A1
(43) Pub. Date: Sep. 10, 2026

(54) INSPECTION SYSTEM

(71) Applicant: CANON KABUSHIKI KAISHA, Tokyo (JP)

(72) Inventor: SHUNSUKE IWANO, Kanagawa (JP)

(21) Appl. No.: 19/555,604

(22) Filed: Mar. 3, 2026

(30) Foreign Application Priority Data
Mar. 4, 2025 (JP) 2025-034135

(51) Int. Cl. G05B 23/02

(52) U.S. Cl. CPC G05B 23/0221

(57) ABSTRACT

An inspection system reading a printed matter to generate read image data and inspecting the read image data includes at least one memory and at least one processor configured to function as an inspection unit configured to perform a plurality of types of inspection, a setting unit configured to receive, from a user, inspection setting for selecting inspection to be performed among the plurality of types of inspection, and a specification unit configured to specify a failure factor based on an inspection result by the inspection unit, wherein the inspection unit performs the plurality of types of inspection irrespective of the inspection setting selected by the user through the setting unit, and wherein the specification unit specifies the failure factor based on inspection results of the plurality of types of inspection.

### BACKGROUND

### Field of the Technology

The present disclosure relates to an image inspection method of inspecting whether a defect has occurred on a printed matter output from a printing apparatus.

### Description of the Related Art

In a printed matter output from a printing apparatus, color materials such as ink and toner may adhere to an unintended position to generate dirt. Alternatively, the color material adheres to a position where an image is to be formed, and a necessary and sufficient color material cannot adhere to the position to cause color loss in which color is lighter than original color.

So-called print defects such dirt and color loss lower quality of the printed matter. Therefore, it is necessary to inspect absence of the defect in the printed matter to guarantee quality of the printed matter.

Visual inspection in which an inspector visually inspects presence/absence of a defect requires much time and cost. Therefore, in recent years, an inspection system that automatically performs inspection without relying on visual inspection has been proposed. More specifically, the inspection system aligns a digital image (reference image) used for printing and a scanned image obtained by scanning a printed matter, performs image collation/determination processing, determines image quality, and detects an image defect.

Japanese Patent Application Laid-Open No. 2024-48122 describes an inspection apparatus that reads characters or a bar code formed on a printed matter, and performs data collation inspection with a reference value. Further, Japanese Patent Application Laid-Open No. 2020-33145 describes an inspection apparatus that inspects a folded corner of a recording medium.

### SUMMARY

According to embodiments of the present disclosure, an inspection system reading a printed matter to generate read image data and inspecting the read image data includes at least one memory and at least one processor configured to function as an inspection unit configured to perform a plurality of types of inspection, a setting unit configured to receive, from a user, inspection setting for selecting inspection to be performed among the plurality of types of inspection, and a specification unit configured to specify a failure factor based on an inspection result by the inspection unit, wherein the inspection unit performs the plurality of types of inspection irrespective of the inspection setting selected by the user through the setting unit, and wherein the specification unit specifies the failure factor based on inspection results of the plurality of types of inspection.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a network configuration example including a printing system.

FIG. 2 is a block diagram illustrating internal configurations of an image forming apparatus, an external controller, and a client personal computer (PC).

FIG. 3 is a diagram illustrating an entire flow of inspection processing.

FIG. 4 is a diagram illustrating a flow of inspection.

FIG. 5 is a diagram illustrating a flow of folded corner inspection.

FIG. 6 is a diagram illustrating a flow of dirt inspection.

FIG. 7 is a diagram illustrating a flow of data collation inspection.

FIGS. 8A and 8B each illustrate a user interface (UI) for inspection setting.

FIG. 9 illustrates a UI for inspection result setting.

FIG. 10 is a diagram illustrating processing contents of the folded corner inspection.

FIG. 11 illustrates a UI for an inspection result.

FIG. 12 is a conceptual diagram of a failure determination result when dirt occurs.

FIG. 13 is a conceptual diagram of a failure determination result when a folded corner occurs.

FIG. 14 is a diagram illustrating a flow of processing for notifying inspection results.

FIG. 15 illustrates a UI for inspection result setting according to a third embodiment.

FIG. 16 is a diagram illustrating a flow of inspection according to a fourth embodiment.

### DESCRIPTION OF THE EMBODIMENTS

Some embodiments of the present disclosure are described in detail with reference to accompanying drawings. The following embodiments do not limit the disclosure according to the claims, and all of combinations of features described in the embodiments are not necessarily essential for solving means of the present disclosure.

### First Embodiment

### Configuration of Entire System

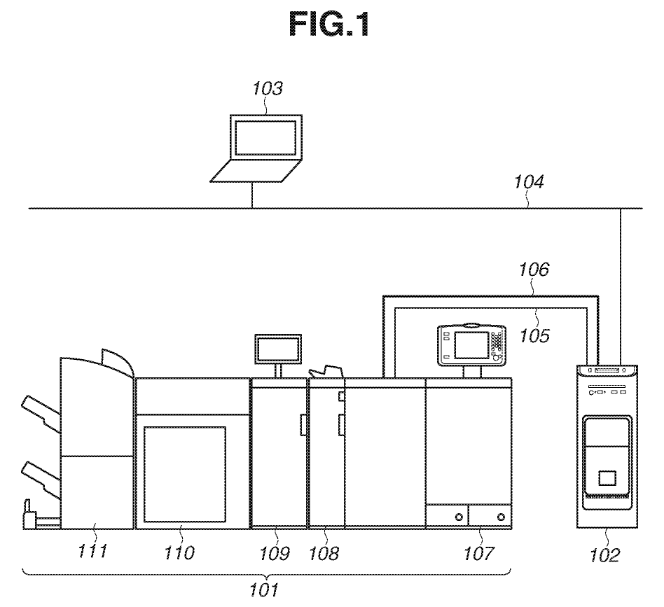

FIG. 1 is a diagram illustrating a network configuration example including a printing system (image processing system) according to a first embodiment. The image processing system includes an image forming apparatus 101 and an external controller 102. The image forming apparatus 101 and the external controller 102 are communicably connected through an internal local area network (LAN) 105 and a video cable 106. The video cable 106 may not be provided as a component, and the internal LAN 105 may function as the video cable 106. The external controller 102 is communicably connected to a client personal computer (PC) 103 through an external LAN 104, and a print instruction is issued from the PC 103 to the external controller 102.

A printer driver that has a function of converting print data into a print description language processible by the external controller 102 is installed in the client PC 103. A user performing printing can issue a print instruction from various kinds of applications through the printer driver. The printer driver transmits the print data to the external controller 102 based on the print instruction from the user. Upon receiving the print instruction from the PC 103, the external controller 102 performs data analysis and rasterization processing, inputs the print data to the image forming apparatus 101, and issues a print instruction.

Next, the image forming apparatus 101 is described. The image forming apparatus 101 is connected to a plurality of apparatuses having different functions, and is configured to perform complicated print processing such as bookbinding.

A printing apparatus 107 forms, by using toner, an image on a medium (hereinafter, referred to as sheet) before printing, conveyed from a sheet feeding unit at a lower part of the printing apparatus 107. The sheet on which the image has been printed in such a manner is hereinafter referred to as a printed sheet.

An inserter 108 inserts an insertion sheet set on an upper part into printed matters printed by the printing apparatus 107. The inserter 108 can insert the sheet at an arbitrary position among the printed sheets printed by and conveyed from the printing apparatus 107.

An inspection apparatus 109 is an apparatus that reads the image of the conveyed printed sheet, and compares the image with a previously registered reference image to determine whether the printed image is normal.

A large-capacity stacker 110 can enable a large number of printed sheets to be stacked. A finisher 111 performs finishing processing on the conveyed printed sheets. The finisher 111 can perform the finishing processing such as stapling, punching, and saddle stich binding, and discharges the processed sheets to a sheet discharge tray.

The printing system illustrated in FIG. 1 has a configuration in which the external controller 102 is connected to the image forming apparatus 101; however, the present disclosure is not limited to the configuration in which the external controller 102 is connected.

For example, the image forming apparatus 101 may be connected to the external LAN 104, and the print data processible by the image forming apparatus 101 may be transmitted from the client PC 103. Alternatively, the print data may be read out from a hard disk drive (HDD) 221 described below inside the printing apparatus 107. In this case, the image forming apparatus 101 performs data analysis and rasterization processing, and then performs print processing.

### Functional Configuration

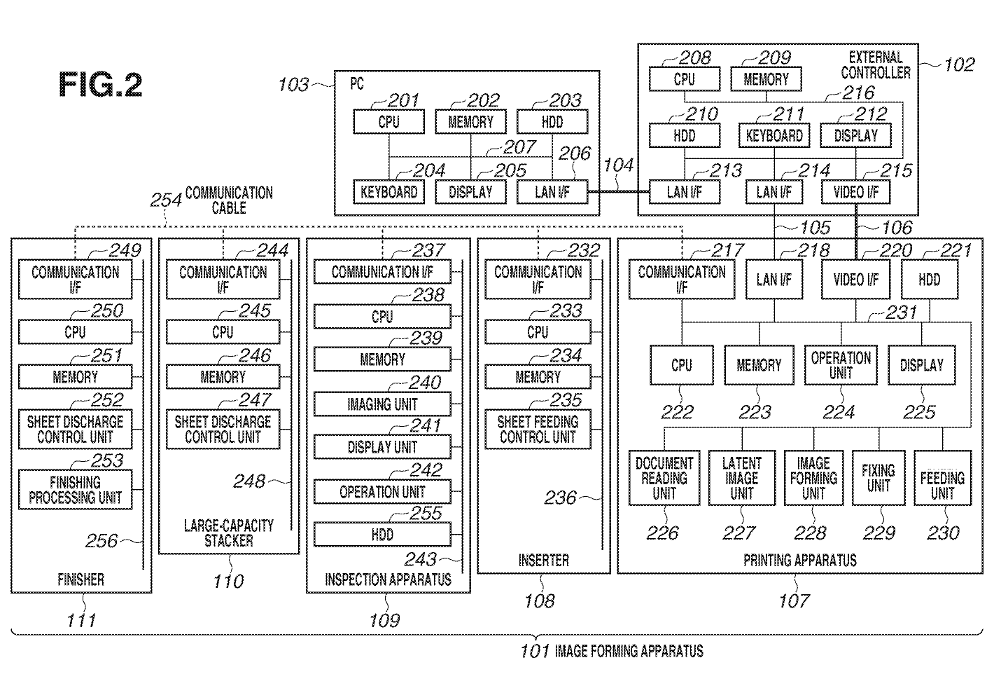

FIG. 2 is a block diagram illustrating system configurations of the image forming apparatus 101, the external controller 102, and the client PC 103. First, a configuration of the printing apparatus 107 of the image forming apparatus 101 is described. The printing apparatus 107 of the image forming apparatus 101 includes a communication interface (I/F) 217, a LAN I/F 218, a video I/F 220, the HDD 221, a central processing unit (CPU) 222, a memory 223, an operation unit 224, and a display 225. The printing apparatus 107 of the image forming apparatus 101 further includes a document reading unit 226, a latent image unit 227, an image forming unit 228, a fixing unit 229, and a sheet feeding unit 230. The components are connected through a system bus 231.

The communication I/F 217 is connected to the inserter 108, the inspection apparatus 109, the large-capacity stacker 110, and the finisher 111 through a communication cable 254, and performs communication for controlling each of the apparatuses.

The LAN I/F 218 is connected to the external controller 102 through the internal LAN 105, and communicates print data and the like. The video I/F 220 is connected to the external controller 102 through the video cable 106, and communicates image data and the like.

The HDD 221 is a storage device storing programs and data. The CPU 222 comprehensively performs image processing control and print control based on the programs and the like stored in the HDD 221. The memory 223 stores programs necessary for the CPU 222 to perform various kinds of processing, and image data, and operates as a work area. The operation unit 224 receives input of various kinds of settings and operation instructions from the user. The display 225 displays setting information on the image forming apparatus 101, a processing state of a print job, and the like. The document reading unit 226 performs processing for reading a document when a copy function or a scan function is used. The document reading unit 226 reads document data by capturing an image by a complementary metal-oxide semiconductor (CMOS) image sensor while illuminating a printed sheet placed by the user with an exposure lamp. The latent image unit 227 is a unit that performs primary charging for irradiating a photosensitive drum with a laser beam in order to develop a toner image, and laser exposure. In the latent image unit 227, the primary charging for charging a surface of the photosensitive drum with a uniform negative potential is first performed. Next, a laser driver irradiates the photosensitive drum with the laser beam while a reflection angle of the laser beam is adjusted by a polygon mirror, thereby forming an electrostatic latent image.

The image forming unit 228 is a unit for transferring the toner to the sheet. The image forming unit 228 includes a development unit, a transfer unit, and a toner replenishment unit, and transfers the toner on the photosensitive drum to the sheet.

In the development unit, the toner negatively charged is caused to adhere from a development cylinder to the electrostatic latent image on the surface of the photosensitive drum to perform visualization. In the transfer unit, primary transfer in which a positive potential is applied to a primary transfer roller and the toner on the surface of the photosensitive drum is transferred to a transfer belt, and secondary transfer in which a positive potential is applied to a secondary transfer outer roller and the toner on the transfer belt is transferred to the sheet are performed. The fixing unit 229 is a unit for melting and fixing the toner on the sheet to the sheet by heat and pressure, and includes a heater, a fixing belt, and a pressurization belt. The sheet feeding unit 230 is a unit for feeding the sheet, and sheet feeding operation and conveyance operation are controlled by rollers and various kinds of sensors.

Next, a configuration of the inserter 108 of the image forming apparatus 101 is described. The inserter 108 of the image forming apparatus 101 includes a communication I/F 232, a CPU 233, a memory 234, and a sheet feeding control unit 235, and the components are connected through a system bus 236. The communication I/F 232 is connected to the printing apparatus 107 through the communication cable 254, and performs communication necessary for control. The CPU 233 performs various kinds of control necessary for sheet feeding based on control programs stored in the memory 234. The memory 234 is a storage device storing the control programs. The sheet feeding control unit 235 controls feeding and conveyance of sheets conveyed from a sheet feeding unit of the inserter 108 and the printing apparatus 107 while controlling rollers and sensors based on instructions from the CPU 233.

Next, a configuration of the inspection apparatus 109 of the image forming apparatus 101 is described. The inspection apparatus 109 of the image forming apparatus 101 includes a communication I/F 237, a CPU 238, a memory 239, an imaging unit 240, a display unit 241, an operation unit 242, and an HDD 255, and the components are connected through a system bus 243. The communication I/F 237 is connected to the printing apparatus 107 through the communication cable 254, and performs communication necessary for control. The CPU 238 performs various kinds of control necessary for inspection based on control programs stored in the memory 239. The memory 239 is a storage device storing the control programs. The imaging unit 240 images the conveyed printed sheet based on an instruction from the CPU 238. The CPU 238 stores an image captured by the imaging unit 240 as a reference image in the memory 239. Further, the CPU 238 compares the image captured by the imaging unit 240 and the reference image stored in the memory 239 to determine whether the printed image is normal. The display unit 241 displays an inspection result, a setting screen, and the like. The operation unit 242 is operated by the user, and receives instructions to change setting of the inspection apparatus 109, to register the reference image, and the like. The HDD 255 stores various kinds of setting information and the image necessary for inspection. The stored various kinds of setting information and the image can be reused.

Next, a configuration of the large-capacity stacker 110 of the image forming apparatus 101 is described. The large-capacity stacker 110 of the image forming apparatus 101 includes a communication I/F 244, a CPU 245, a memory 246, and a sheet discharge control unit 247, and the components are connected through a system bus 248. The communication I/F 244 is connected to the printing apparatus 107 through the communication cable 254, and performs communication necessary for control. The CPU 245 performs various kinds of control necessary for sheet discharge based on control programs stored in the memory 246. The memory 246 is a storage device storing the control programs. The sheet discharge control unit 247 performs control to convey the conveyed printed sheet to a stack tray, an escape tray, or the subsequent finisher 111 based on an instruction from the CPU 245.

Next, a configuration of the finisher 111 of the image forming apparatus 101 is described. The finisher 111 of the image forming apparatus 101 includes a communication I/F 249, a CPU 250, a memory 251, a sheet discharge control unit 252, and a finishing processing unit 253, and the components are connected through a system bus 256. The communication I/F 249 is connected to the printing apparatus 107 through the communication cable 254, and performs communication necessary for control. The CPU 250 performs various kinds of control necessary for finishing and sheet discharge based on control programs stored in the memory 251. The memory 251 is a storage device storing the control programs. The sheet discharge control unit 252 controls conveyance and discharge of the printed sheet based on instructions from the CPU 250. The finishing processing unit 253 controls finishing processing such as stapling, punching, and saddle stich binding based on instructions from the CPU 250.

Next, a configuration of the external controller 102 is described. The external controller 102 includes a CPU 208, a memory 209, an HDD 210, a keyboard 211, a display 212, a LAN I/F 213, a LAN I/F 214, and a video I/F 215, and the components are connected through a system bus 216. The CPU 208 controls comprehensive processing based on programs and data stored in the HDD 210. For example, the CPU 208 comprehensively performs processing such as reception of print data from the client PC 103, raster image processer (RIP) processing, and transmission of print data to the image forming apparatus 101. Further, the CPU 208 can also perform RIP processing for reference image data. More specifically, in the RIP processing for reference image data, for example, the CPU 208 generates an image by converting resolution from 600 dpi into 300 dpi, whereas in the RIP processing for print data, the CPU 208 generates an image without reducing the resolution.

The memory 209 stores programs and data necessary for the CPU 208 to perform various kinds of processing, and operates as a work area. The HDD 210 stores programs and data necessary for operation such as print processing. The keyboard 211 is a device for inputting operation instructions of the external controller 102. The display 212 displays information on an execution application and the like of the external controller 102 by video signals of a still image and a moving image. The LAN I/F 213 is connected to the client PC 103 through the external LAN 104, and communicates a print instruction and the like. The LAN I/F 214 is connected to the image forming apparatus 101 through the internal LAN 105, and communicates a print instruction and the like. The external controller 102 can mutually exchange various kinds of data with the printing apparatus 107, the inserter 108, the inspection apparatus 109, the large-capacity stacker 110, and the finisher 111 through the internal LAN 105 and the communication cable 254.

The video I/F 215 is connected to the image forming apparatus 101 through the video cable 106, and communicates print data and the like. Next, a configuration of the client PC 103 is described. The client PC 103 includes a CPU 201, a memory 202, an HDD 203, a keyboard 204, a display 205, and a LAN I/F 206, and the components are connected through a system bus 207. The CPU 201 creates print data and performs a print instruction based on a document processing program and the like stored in the HDD 203. In addition, the CPU 201 comprehensively controls the devices connected to the system bus 207. The memory 202 stores programs and data necessary for the CPU 201 performs various kinds of processing, and operates as a work area.

The HDD 203 stores programs and data necessary for operation such as print processing. The keyboard 204 is a device for inputting operation instructions of the PC 103. The display 205 displays information on an execution application and the like of the client PC 103 by video signals of a still image and a moving image. The LAN I/F 206 is connected to the external LAN 104, and performs communication such as issuing a print instruction and receiving an RIP image.

In the above description, the external controller 102 and the image forming apparatus 101 are connected through the internal LAN 105 and the video cable 106; however, it is sufficient to transmit/receive data necessary for printing, and for example, connection may be established only through the video cable. Further, it is sufficient for each of the memory 202, the memory 209, the memory 223, the memory 234, the memory 239, the memory 246, and the memory 251 to be a storage device for holding data and programs. For example, each of the memories may be replaced with a volatile random access memory (RAM), a nonvolatile read only memory (ROM), a built-in HDD, an external HDD, a universal serial bus (USB) memory, or the like.

The inspection apparatus 109 inspects a sent printed sheet image based on preset inspection types. The printed sheet image indicates a printed sheet portion obtained by excluding a background portion from a scanned image. Inspection of the printed sheet image is performed by comparing a preset reference image and the sent printed sheet image. Examples of a method of comparing the images include a method of comparing pixel values on each image position, a method of comparing positions of objects by edge detection, and a character recognition method using extraction of character data by optical character recognition (OCR). Examples of the inspection type include deviation of a print position, color tone of an image, density of an image, a streak, blur, missing print, and a folded corner.

### Entire Flow of Inspection Processing

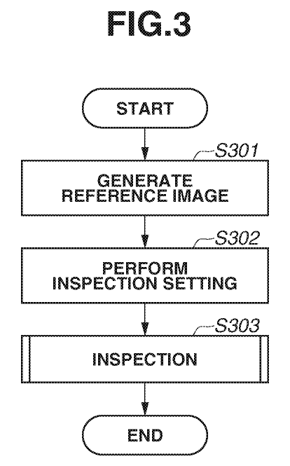

FIG. 3 is a flowchart illustrating an entire flow of inspection processing performed by the inspection apparatus 109. The processing illustrated in FIG. 3 is performed by the CPU 238 of the inspection apparatus 109.

First, in step S301, the inspection apparatus 109 registers a reference image as reference of inspection. As the reference image, a simulated image using print data previously received through the communication I/F 237, or scan data previously captured by the inspection apparatus 109 is used. Further, at this time, reference feature points are acquired from the reference image, and are stored together with the reference image in the HDD 255. In the present embodiment, feature amounts are determined by Harris corner detection, and top eight amounts are used as the feature points. Harris corner detection is an example of feature point extraction, and the feature point extraction is not limited thereto. In the present embodiment, the feature points in the reference image are referred to as reference feature points.

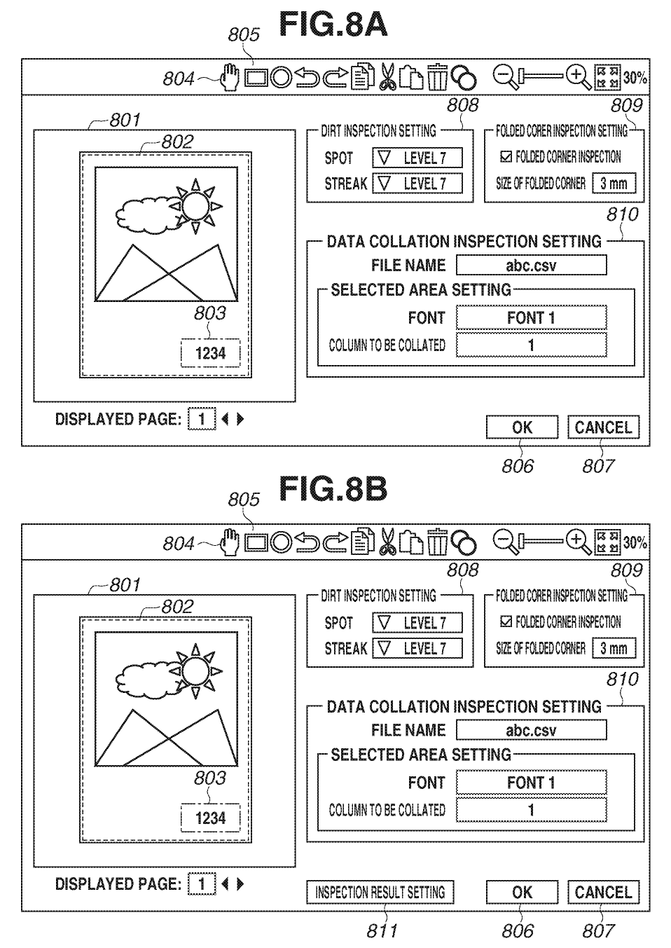

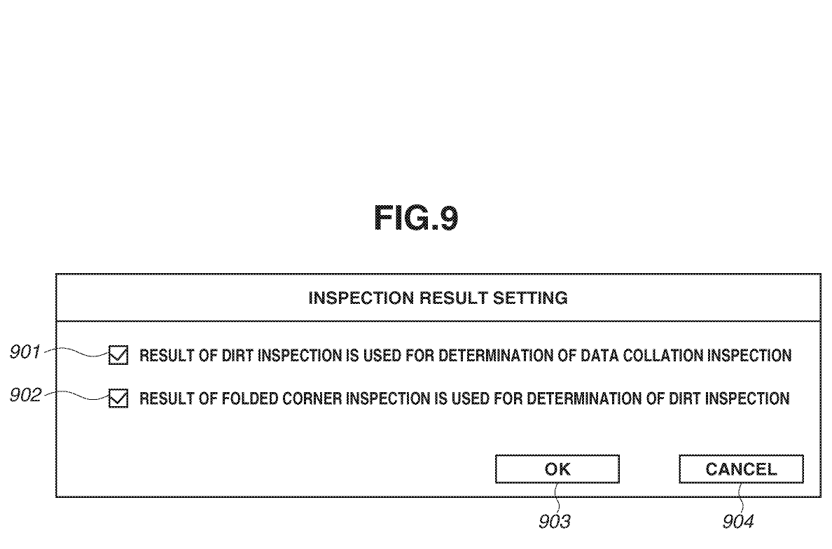

In step S302, the inspection apparatus 109 performs detailed inspection area setting of an inspection level of dirt inspection, an inspection type, an inspection area, and the like based on operation by the user. The setting is performed using an inspection setting screen illustrated in FIGS. 8A and 8B and FIG. 9. Various kinds of setting contents illustrated in FIGS. 8A and 8B and FIG. 9 are described below.

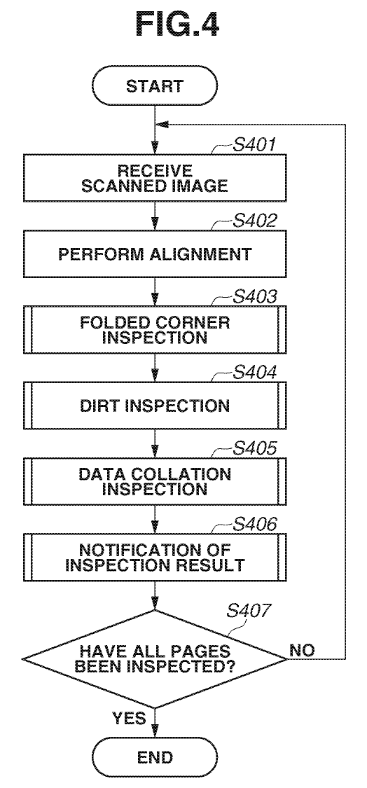

Finally, in step S303, inspection is performed. When the inspection is started, in step S303, the CPU 238 performs inspection of the scanned image based on the reference image generated in step S301 and the inspection setting performed in step S302. The inspection is described below with reference to FIG. 4.

### Inspection Setting

A user interface (UI) screen for performing the setting of the inspection, and a flow of the inspection setting are described with reference to FIG. 8A.

FIG. 8A is a schematic diagram of an inspection setting screen. The inspection setting screen is displayed on the display unit 241 by the CPU 238 of the inspection apparatus 109, and receives inspection setting operation by the user through the operation unit 242.

A preview display screen 801 displays an inspection setting reference image. In a case where a print job includes a plurality of pages, operation for switching the inspection setting reference image to be displayed as a preview is received, and a reference image in each page is displayed.

Frames 802 and 803 indicate inspection areas arranged on the preview. The inspection areas are arranged by an inspection area arrangement button 805 described below, and sizes and positions of the inspection areas can be changed by drag operation by the user. The frame 802 illustrates an arrangement example of a dirt inspection area. The frame 803 illustrates an arrangement example of a data inspection target area of a character string.

An inspection area selection button 804 is illustrated in FIGS. 8A and 8B. When the user presses the inspection area selection button 804, and then clicks or taps the frame 802 or 803 indicating the inspection area, operation for selecting the inspection area is received.

The inspection area arrangement button 805 is illustrated in FIGS. 8A and 8B. When the inspection area arrangement button 805 is pressed, a pull-down menu of an inspection area type is displayed. When an area to be designated as an inspection area on the preview display is selected by drag operation, the pull-down menu receives inspection area arrangement operation.

An OK button 806 is illustrated in FIGS. 8A and 8B. When the OK button 806 is pressed, the inspection area setting is saved. A cancel button 807 is illustrated in FIGS. 8A and 8B. When the cancel button 807 is pressed, the inspection area setting is discarded. AUI 808 for setting an inspection level of the dirt inspection is illustrated in FIGS. 8A and 8B. A threshold as a reference for determining failure in the inspection processing can be set by adjusting an inspection level of each of a spot defect and a streak defect.

A UI 809 for setting the folded corner inspection is illustrated in FIGS. 8A and 8B. The user can perform the folded corner inspection by inputting a maximum allowable value in units of mm in a frame. The folded corner inspection is performed only in a case where a checkbox is checked, whereas the folded corner inspection is not performed in a case where the checkbox is not checked.

A UI 810 for setting the data collation inspection is illustrated in FIGS. 8A and 8B. Collation data is selected by a file selection method. The collation data is a reference comma separated value (CSV) file for data inspection, collated in data inspection. The reference CSV file is a file to be previously prepared by the user, and is a file listing reference character strings for a reading result of a character string and a bar code. In execution of the inspection, a reading result of a character string or a bar code is collated with the reference character strings listed in the reference CSV file to perform failure determination. A setting value of each inspection area selected by the inspection area selection button 804 is displayed, and a column of a CSV file to be collated, and a font in a case of a character string or a type of a bar code in a case of a bar code are selected.

### Inspection

FIG. 4 is a flowchart illustrating a flow of processing performed by the inspection apparatus 109 in the inspection. The processing illustrated in FIG. 4 is performed by the CPU 238 of the inspection apparatus 109. Here, an example in which three types of inspection are performed is described; however, the inspection is not limited thereto. An execution order of the inspection is changeable.

In step S401, the inspection apparatus 109 receives a scanned image to be inspected. When the inspection processing starts, the inspection apparatus 109 transitions to a scan standby state. Thereafter, when the printing apparatus 107 performs printing, and a printed sheet passes through the imaging unit 240, scanning is performed by the imaging unit 240. In step S402, the inspection apparatus 109 performs alignment processing of the reference image generated in step S301 and the scanned image received in step S401. First, feature points of a pattern of the reference image are extracted. Next, the scanned image is searched to find points corresponding to the extracted feature points. Thereafter, affine transformation parameters between the feature points and the corresponding points are calculated, and affine transformation is performed on the scanned image to align the reference image and the scanned image.

In steps S403 to S405, a plurality of types of inspection for detecting different types of defects is performed on the aligned scanned image. In the present embodiment, an example in which the plurality of types of inspection is sequentially performed is described; however, the plurality of types of inspection may be performed in parallel. In step S403, the inspection apparatus 109 performs the folded corner inspection on the aligned scanned image. Details are described below.

In step S404, the inspection apparatus 109 performs the dirt inspection on the aligned scanned image. Details are described below. In step S405, the inspection apparatus 109 performs the data collation inspection on the aligned scanned image. Details are described below. In step S406, the inspection apparatus 109 notifies the user of inspection results obtained in steps S403 to S405 by displaying the inspection results on the display unit 241. Details are described below. In step S407, the inspection apparatus 109 determines whether all pages to be inspected have been inspected. In a case where a determination result is YES (YES in step S407), the processing ends. In a case where the determination result is NO (NO in step S407), the processing returns to step S401, and the inspection apparatus 109 transitions to the scan standby state.

### Folded Corner Inspection

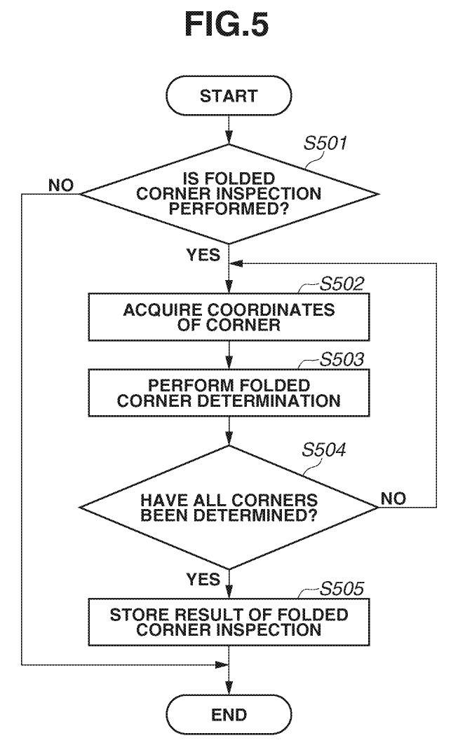

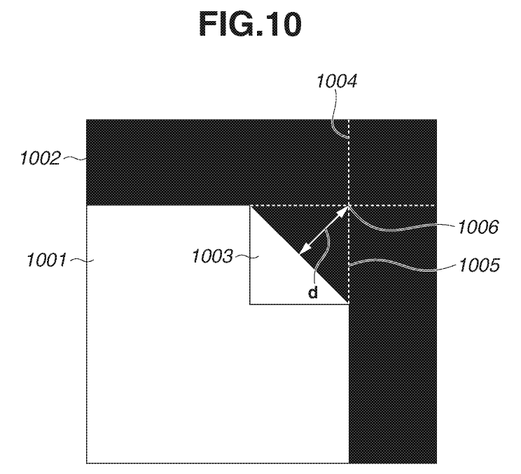

Processing of the folded corner inspection in step S403 is described with reference to FIGS. 5 and 10. The processing illustrated in FIG. 5 is performed by the CPU 238 of the inspection apparatus 109. In step S501, the inspection apparatus 109 determines whether to perform the folded corner inspection. In a case where the checkbox in the folded corner inspection setting 809 illustrated in FIGS. 8A and 8B is checked, the folded corner inspection is performed. Further, in a case where the checkbox in the folded corner inspection setting 809 is not checked, but a vicinity of a corner of the sheet is designated as the dirt inspection area 802, the folded corner inspection is performed. In this case, a size of the folded corner is set to a default value empirically determined, for example, 3 mm. As a result, even in a case where non-execution of the folded corner inspection is designated by the user, the folded corner inspection is automatically performed on the dirt inspection area. Otherwise, the folded corner inspection is not performed. In a case where it is determined that the folded corner inspection is performed (YES in step S501), the processing proceeds to step S502. In a case where it is determined that the folded corner inspection is not performed (NO in step S501), the processing ends.

In step S502, the inspection apparatus 109 acquires coordinates of one of four corners of the sheet on the scanned image. The coordinates of the corner indicate coordinates of an ideal corner in a case where a corner is not folded. The coordinates of the corner can be acquired by detecting four sides of the sheet and determining intersections. FIG. 10 is a conceptual diagram of a folded corner of the sheet of the scanned image. In FIG. 10, a sheet area 1001 and a background area 1002 of the imaging unit 240 captured in the scanned image are illustrated. A folded corner 1003 is illustrated in FIG. 10. Straight lines 1004 and 1005 of detected four sides of the sheet are illustrated in FIG. 10. The straight lines can be detected by a well-known technique such as Hough transformation. An intersection 1006 of the straight line 1004 and the straight line 1005 is illustrated in FIG. 10, and denotes the coordinates of the ideal corner in the case where the corner is not folded.

In step S503, the inspection apparatus 109 performs folded corner determination. The inspection apparatus 109 calculates a distance d between the coordinates of the corner 1006 acquired in step S502 and the sheet area 1001 illustrated in FIG. 10. In a case where the distance d exceeds the size of the folded corner designated in the folded corner inspection setting 809, it is determined that the folded corner has occurred. In step S504, the inspection apparatus 109 determines whether the folded corner determination has been performed on all corners of the sheet. In a case where the folded corner determination has been performed on all corners of the sheet (YES in step S504), the processing proceeds to step S505. In a case where the folded corner determination has not been performed on all corners of the sheet (NO in step S504), the processing returns to step S502, and the folded corner determination is performed on a remaining corner. In step S505, the inspection apparatus 109 stores a result of the folded corner inspection in the memory 239 of the inspection apparatus 109. Information stored as the result of the folded corner inspection includes a corner where the folded corner has occurred, for example, an upper left corner or a lower right corner, the coordinates of each of the corners acquired in step S502, and the size of the folded corner calculated as the distance d in step S503. After the result of the folded corner inspection is stored, the processing of the folded corner inspection ends.

### Dirt Inspection

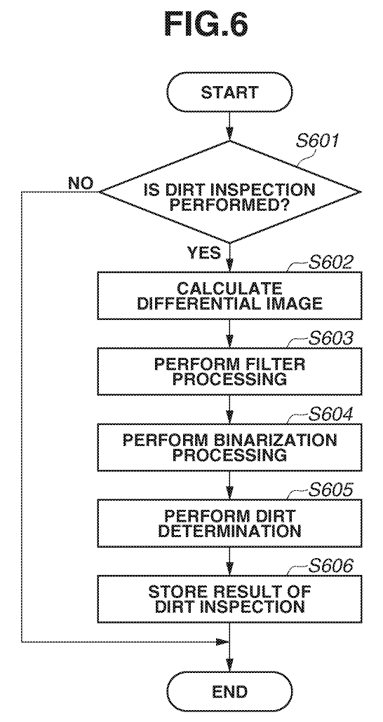

Processing of the dirt inspection in step S404 is described with reference to FIG. 6. The processing illustrated in FIG. 6 is performed by the CPU 238 of the inspection apparatus 109. In step S601, the inspection apparatus 109 determines whether to perform the dirt inspection. In a case where the dirt inspection area 802 is arranged in the inspection setting screen illustrated in FIGS. 8A and 8B, the dirt inspection is performed. Further, in a case where the dirt inspection area 802 is not arranged, but the data inspection target area 803 is designated, the dirt inspection is performed. In this case, the inspection level of the dirt inspection is set to a default value empirically determined, and the data inspection target area 803 is also handled as the dirt inspection area 802. As a result, even in a case where non-execution of the dirt inspection is designated by the user, the dirt inspection is automatically performed on the data inspection target area. Otherwise, the dirt inspection is not performed. In a case where it is determined that the dirt inspection is performed (YES in step S601), the processing proceeds to step S602. In a case where it is determined that the dirt inspection is not performed (NO in step S601), the processing ends.

In step S602, the inspection apparatus 109 calculates a differential image between the reference image and the scanned image aligned in step S402. The inspection apparatus 109 generates the differential image by comparing the reference image and the scanned image for each pixel to acquire a differential value of a pixel value (e.g., density value for each of RGB colors) for each pixel. In step S603, the inspection apparatus 109 performs filter processing for emphasizing a specific shape on the differential image acquired in step S602. For example, to emphasize a defect having a spot shape, a filter for emphasizing a circular difference is used, and to emphasize a defect of a streak shape, a filter for emphasizing a linear difference is used.

In step S604, the inspection apparatus 109 performs binarization processing on the difference image subjected to the emphasizing processing such that the differential value greater than or equal to a threshold is set to "1" and the differential value less than or equal to the threshold is set to "0". In step S605, the inspection apparatus 109 determines whether the pixel that has the differential value exceeding the threshold and set to "1" is present in an area designated by the dirt inspection area 802 in the image subjected to the binarization processing. In a case where such a pixel is present, it is determined that dirt is present at coordinates of the pixel. In step S606, the inspection apparatus 109 stores a result of the dirt inspection in the memory 239 of the inspection apparatus 109. The inspection apparatus 109 stores the coordinates determined to have dirt in step S605. After the result of the dirt inspection is stored, the processing of the dirt inspection ends.

### Data Collation Inspection

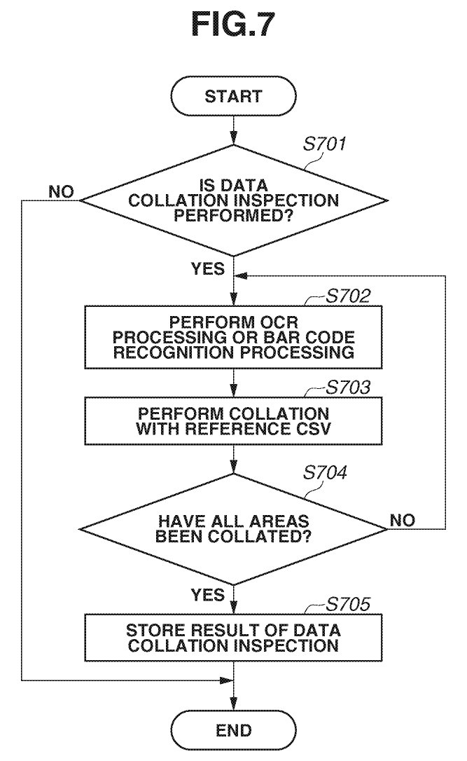

Processing of the data collation inspection in step S405 is described with reference to FIG. 7. The processing illustrated in FIG. 7 is performed by the CPU 238 of the inspection apparatus 109.

In step S701, the inspection apparatus 109 determines whether to perform the data collation inspection.

In a case where the data inspection target area 803 is arranged in the inspection setting screen illustrated in FIGS. 8A and 8B, it is determined that the data collation inspection is performed (YES in step S701), and the processing proceeds to step S702. In a case where the data inspection target area 803 is not arranged, it is determined that the data collation inspection is not performed (NO in step S701), and the processing ends.

In step S702, the inspection apparatus 109 performs character string recognition (optical character recognition (OCR) processing or bar code recognition processing on the area 803 based on the inspection setting set in the inspection setting screen illustrated in FIGS. 8A and 8B. A recognition result is stored in the memory 239 of the inspection apparatus 109 in association with the inspection area to be recognized.

In step S703, the inspection apparatus 109 collates the reference character string corresponding to each inspection area described in the reference CSV file set in the inspection setting screen illustrated in FIGS. 8A and 8B, with the recognized data stored in the memory 239 in step S702. In a case where the recognized data and the reference character string are coincident with each other, it is determined to be a success. In a case where the recognized data and the reference character string are not coincident with each other, it is determined to be a failure.

In step S704, the inspection apparatus 109 determines whether the data collation inspection has been performed on all data inspection target areas set in the inspection setting screen illustrated in FIGS. 8A and 8B. In a case where the data collation inspection has been performed on all data inspection target areas (YES in step S704), the processing proceeds to step S705. In a case where the data collation inspection has not been performed on all the data inspection target areas (NO in step S704), the processing returns to step S702, and the data collation inspection is performed on a remaining data inspection target area.

In step S705, the inspection apparatus 109 stores a result of the data collation inspection in the memory 239 of the inspection apparatus 109. The recognized data and the reference character string, and the determination result are stored for each data inspection target area. After the result of the data collation inspection is stored, the processing of the data collation inspection ends.

### Notification of Inspection Result

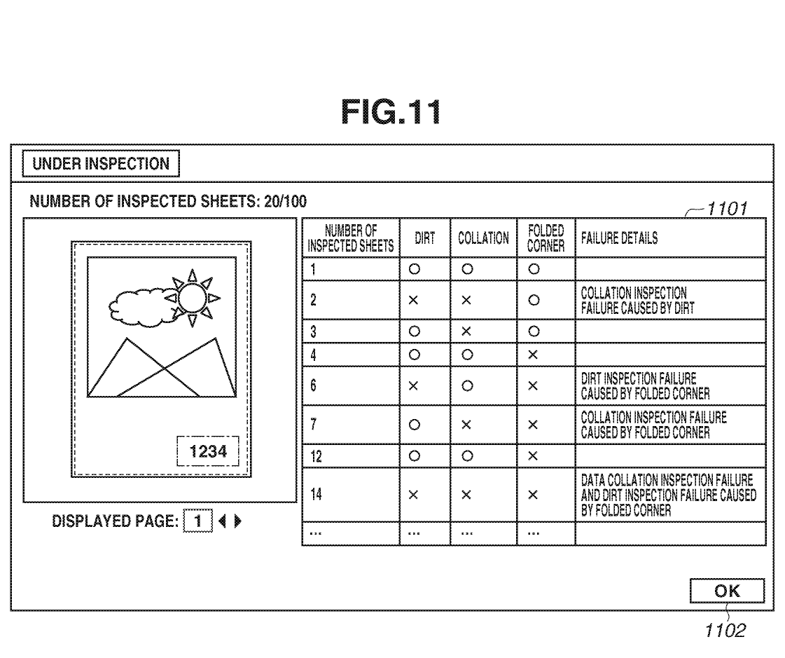

Processing of notification of the inspection result in step S406 is described with reference to FIG. 11 to FIG. 14.

FIG. 11 is a schematic diagram of an inspection result screen. The inspection result screen is displayed on the display unit 241 by the CPU 238 of the inspection apparatus 109 during execution of the inspection processing and after end of the inspection processing, and receives operation by the user through the operation unit 242. An inspection result display field 1101 is illustrated in FIG. 11. The number of inspected sheets indicating a sheet number under inspection, results of the inspection performed on the scanned image in steps S403 to S405, and details of the inspection results are displayed in association with each other. A symbol "○" is displayed for a type having the inspection result of a success, whereas a symbol "×" is displayed for a type having the inspection result of a failure. An OK button 1102 is illustrated in FIG. 11. When the OK button 1102 is pressed, display of the inspection result screen ends.

As described above, in a case where a predetermined condition is satisfied, for example, in a case where one of the inspection results is a failure and a reason for the failure in the one inspection result relates to the other inspection target, the reason for the failure is displayed in a failure detail field illustrated in FIG. 11. For example, in FIG. 11, a collation inspection failure caused by a dirt failure is displayed in the failure detail field. This corresponds to a case where dirt occurs on the inspection target such as a bar code, a character string, or a QR code^{®} in the data collation inspection. The data to be collated cannot be correctly read from the scanned image due to dirt, which results in a failure. In other words, interference in this example indicates that the collation target in the collation inspection is dirty.

For example, in FIG. 11, the result of the dirt inspection is a success in a case where the result of the folded corner inspection is a failure. This corresponds to a case where a folded corner is not included in the target area of the dirt inspection, for example, because a folded corner amount is small. In other words, if the folded corner amount is large, and the folded corner is included in the target area of the dirt inspection, the result of the dirt inspection may be a failure depending on a threshold of dirt detection. In this case, a dirt failure caused by the folded corner is displayed in the failure detail field.

For example, in FIG. 11, the result of the collation inspection is a success in a case where the result of the folded corner inspection is a failure. This corresponds to a case where a folded corner is not included in the target area of the collation inspection, for example, because a folded corner amount is small, and data to be collated is correctly read. In other words, if the folded corner amount is large, and the folded corner is included in the target area of the collation inspection, in a case where data to be collated cannot be correctly read, the result of the collation inspection may be a failure. In this case, a collation inspection failure caused by the folded corner is displayed in the failure detail field.

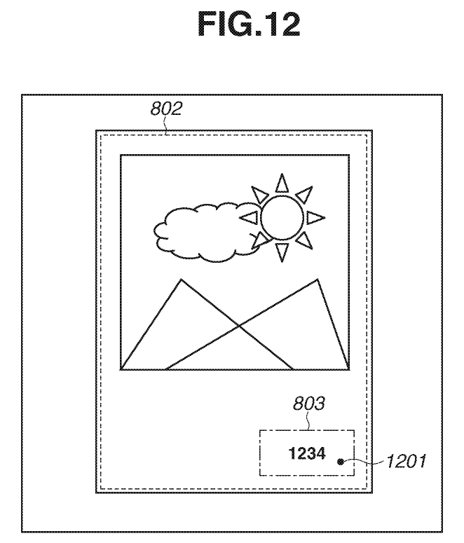

FIG. 12 illustrates a display example on the display screen of the inspected scanned image in FIG. 11.

FIG. 12 illustrates an example of the scanned image in which a dirt 1201 having a spot shape occurs in the dirt inspection area 802 and the data inspection target area 803. The dirt 1201 is determined to be a failure in the dirt inspection performed in step S404, and may be determined to be a failure also in the data collation inspection performed in step S405. In a case of the example illustrated in FIG. 12, a reference character string in the data collation inspection is "1234", but the recognized data is "1234.", and it is determined to be a failure in the data collation inspection.

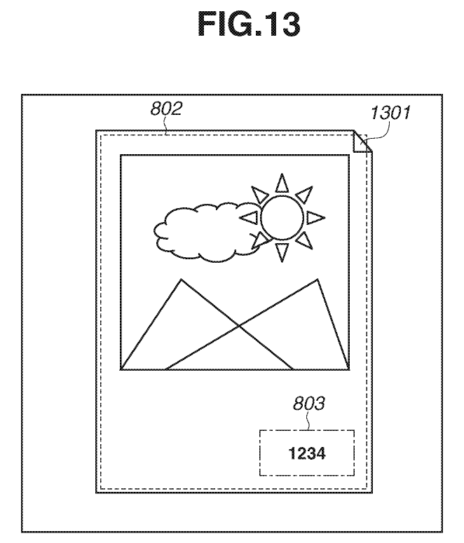

FIG. 13 illustrates a display example on the display screen of the inspected scanned image in FIG. 11.

FIG. 13 illustrates an example of the scanned image in which a folded corner 1301 occurs in the dirt inspection area 802. The folded corner 1301 is determined to be a failure in the folded corner inspection performed in step S403, and may be determined to be a failure also in the dirt inspection performed in step S404. In a case of the example illustrated in FIG. 13, the folded corner and the background area 1002 of the imaging unit 240 are included in the dirt inspection area 802 at coordinates near the folded corner. As a result, the difference value with the reference image is acquired in step S602, and it is determined to be a failure in the dirt inspection.

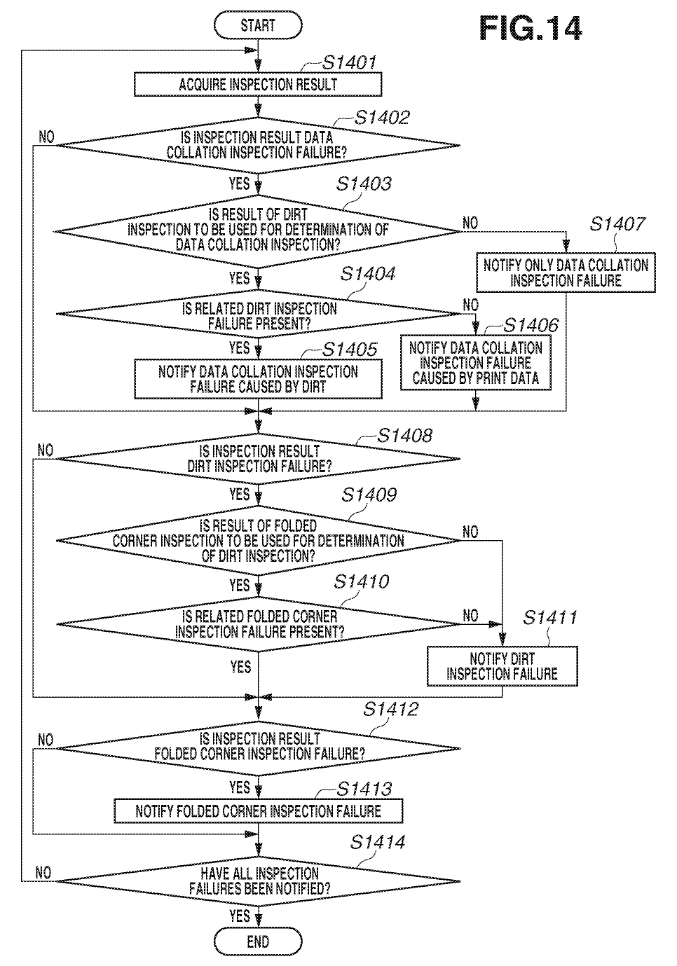

FIG. 14 illustrates a flow of the processing of notification of the inspection result. The processing illustrated in FIG. 14 is performed by the CPU 238 of the inspection apparatus 109. In step S1401, the inspection apparatus 109 acquires the inspection result stored in the memory 239 of the inspection apparatus 109.

In step S1402, the inspection apparatus 109 determines whether the inspection result acquired in step S1401 is a data collation inspection failure. In a case where the inspection result is a data collation inspection failure (YES in step S1402), the processing proceeds to step S1403. In a case where the inspection result is not a data collation inspection failure (NO in step S1402), the processing proceeds to step S1408. In step S1403, the inspection apparatus 109 determines whether to use the result of the dirt inspection for determination of the data collation inspection. In a case where the data inspection target area and the dirt inspection area are overlapped with each other, the result of the dirt inspection is used, whereas in a case where the data inspection target area and the dirt inspection area are not overlapped with each other, the result of the dirt inspection is not used. In a case where the result of the dirt inspection is used (YES in step S1403), the processing proceeds to step S1404. In a case where the result of the dirt inspection is not used (NO in step S1403), the processing proceeds to step S1407.

In step S1404, the inspection apparatus 109 determines whether a dirt inspection failure related to the currently referred data collation inspection failure is present. To determine whether a related dirt inspection failure is present, for example, the coordinates of the data inspection target area stored in the memory 239 of the inspection apparatus 109 and the coordinates determined to have dirt are compared. In a case where the coordinates determined to have dirt are present in the data inspection target area, it is determined that a related dirt inspection failure is present. In a case where the coordinates determined to have dirt are absent in the data inspection target area, it is determined that a related dirt inspection failure is absent.

Further, in a case where, in the dirt inspection, a defect having a streak shape is detected at coordinates in an up-down direction or a left-right direction of the data inspection target area, it may be determined that a related dirt inspection failure is present. In a case where a related dirt inspection failure is present (YES in step S1404), the processing proceeds to step S1405. In a case where a related dirt inspection failure is absent (NO in step S1404), the processing proceeds to step S1406.

In step S1405, the inspection apparatus 109 notifies the data collation inspection failure caused by dirt. The inspection apparatus 109 performs the notification by displaying a symbol "×" in the data collation inspection result field of the inspection result display field 1101, and displaying "collation inspection failure caused by dirt" in the failure detail field.

In step S1406, the inspection apparatus 109 notifies the data collation inspection failure caused by the print data. The inspection apparatus 109 displays a symbol "×" in the data collation inspection result field of the inspection result display field 1101.

In step S1407, the inspection apparatus 109 notifies only the data collation inspection failure.

The inspection apparatus 109 performs the notification by displaying a symbol "×" in the data collation inspection result field of the inspection result display field 1101.

In step S1408, the inspection apparatus 109 determines whether the inspection result acquired in step S1401 is a dirt inspection failure. In a case where the inspection result is a dirt inspection failure (YES in step S1408), the processing proceeds to step S1409. In a case where the inspection result is not a dirt inspection failure (NO in step S1408), the processing proceeds to step S1412.

In step S1409, the inspection apparatus 109 determines whether to use the result of the folded corner inspection for determination of the dirt inspection. In a case where a vicinity of the corner of the sheet is designated as the dirt inspection area 802, the result of the folded corner inspection is used, whereas in a case where the vicinity of the corner of the sheet is not designated as the dirt inspection area 802, the result of the folded corner inspection is not used. In a case where the result of the folded corner inspection is used (YES in step S1409), the processing proceeds to step S1410. In a case where the result of the folded corner inspection is not used (NO in step S1409), the processing proceeds to step S1411.

In step S1410, the inspection apparatus 109 determines whether a folded corner inspection failure related to the currently referred dirt inspection failure is present. To determine whether a related folded corner inspection failure is present, for example, the coordinates determined to have dirt stored in the memory 239 of the inspection apparatus 109 and the coordinates of the folded corner that are calculated from the coordinates of the corner determined to be folded and the size of the folded corner are compared. In a case where overlapping coordinates are present, it is determined that a related folded corner inspection failure is present. In a case where overlapping coordinates are absent, it is determined that a related folded corner inspection failure is absent. In a case where a related folded corner inspection failure is present (YES in step S1410), the processing proceeds to step S1412 without notifying the dirt inspection failure. In a case where a related folded corner inspection failure is absent (NO in step S1410), the processing proceeds to step S1411. The dirt inspection failure not notified at this time is notified as the folded corner inspection failure in step S1413 described below.

In step S1411, the inspection apparatus 109 notifies the dirt inspection failure. The inspection apparatus 109 performs the notification by displaying a symbol "×" in the dirt inspection result field of the inspection result display field 1101. In step S1412, the inspection apparatus 109 determines whether the inspection result acquired in step S1401 is a folded corner inspection failure. In a case where the inspection result is a folded corner inspection failure (YES in step S1412), the processing proceeds to step S1413. In a case where the inspection result is not a folded corner inspection failure (NO in step S1412), the processing proceeds to step S1414.

In step S1413, the inspection apparatus 109 notifies the folded corner inspection failure. The inspection apparatus 109 performs the notification by displaying a symbol "×" in the folded corner inspection result field of the inspection result display field 1101. In step S1414, the inspection apparatus 109 determines whether all inspection failures have been notified. In a case where all inspection failures have been notified (YES in step S1414), a symbol "○" is displayed in the inspection result field where a symbol "×" is not displayed in a case where execution of the inspection is designated by the user, thereby notifying that a defect is absent. In a case where execution of the inspection is not designated by the user, a symbol "-" is displayed to notify that the inspection has not been performed, and the processing ends. In a case where all the inspection failures have not been notified (NO in step S1414), the processing returns to step S1401.

As described above, according to the present embodiment, in the inspection apparatus that can perform the plurality of inspection functions of detecting different types of defects, it is possible to prevent an erroneous failure factor from being provided to the user. In the present embodiment, as the plurality of inspection functions, the dirt inspection, the folded corner inspection, and the data collation inspection are described as examples; however, the inspection functions may be other inspection functions such as inspection of colors of an image formed on the printed matter.

### Second Embodiment

In the first embodiment, the example in which, in the case where the user turns on one of the plurality of types of inspection functions, the other inspection function is automatically turned on is described. On the other hand, the user may select whether to automatically turn on the other inspection function. In a second embodiment, an example of control for enabling the user to select whether to automatically turn on the other inspection function is described. In the following, only differences from the first embodiment are described in detail.

The UI screen for setting the inspection, and a flow of the inspection setting are described with reference to FIG. 8B and FIG. 9.

FIG. 8B is a schematic diagram of an inspection setting screen according to the second embodiment. The inspection setting screen is displayed on the display unit 241 by the CPU 238 of the inspection apparatus 109, and receives inspection setting operation by the user through the operation unit 242. A button 811 for opening an inspection result setting screen is illustrated in FIG. 8B. The inspection result setting screen is described below with reference to FIG. 9.

FIG. 9 is a schematic diagram of the inspection result setting screen. The inspection result setting screen is displayed on the display unit 241 by the CPU 238 of the inspection apparatus 109 in response to pressing operation of the button 811 by the user, and receives inspection setting operation by the user through the operation unit 242. A UI 901 for setting whether to use the result of the dirt inspection for determination of the data collation inspection is illustrated in FIG. 9. A UI 902 for setting whether to use the result of the folded corner inspection for determination of the dirt inspection is illustrated in FIG. 9. An OK button 903 is illustrated in FIG. 9. When the OK button 903 is pressed, the inspection result setting can be saved. A cancel button 904 is illustrated in FIG. 9. When the cancel button 904 is pressed, the inspection result setting is discarded.

Processing of the folded corner inspection according to the second embodiment is described. In step S501, the inspection apparatus 109 determines whether to perform the folded corner inspection. In a case where the checkbox in the folded corner inspection setting 809 illustrated in FIGS. 8A and 8B is checked, the folded corner inspection is performed. Further, in a case where the checkbox in the folded corner inspection setting 809 is not checked, but a checkbox in the setting 902 indicating whether to use the result of the folded corner inspection for determination of the dirt inspection illustrated in FIG. 9 is checked, the folded corner inspection is performed. In this case, a size of the folded corner is set to a default value empirically determined, for example, 3 mm. In a case where both checkboxes are not checked, the folded corner inspection is not performed. In a case where it is determined that the folded corner inspection is performed (YES in step S501), the processing proceeds to step S502. In a case where it is determined that the folded corner inspection is not performed (NO in step S501), the processing ends.

Processing of the dirt inspection according to the second embodiment is described. In step S601, the inspection apparatus 109 determines whether to perform the dirt inspection. In a case where the dirt inspection area 802 is arranged in the inspection setting screen illustrated in FIGS. 8A and 8B, the dirt inspection is performed. Further, in a case where the dirt inspection area 802 is not arranged, but a checkbox in the setting 901 indicating whether to use the result of the dirt inspection for determination of the data collation inspection illustrated in FIG. 9 is checked, the dirt inspection is performed. In this case, the inspection level of the dirt inspection is set to a default value empirically determined, and the data inspection target area 803 is also handled as the dirt inspection area 802. In a case where both checkboxes are not checked, the dirt inspection is not performed. In a case where it is determined that the dirt inspection is performed (YES in step S601), the processing proceeds to step S602. In a case where it is determined that the dirt inspection is not performed (NO in step S601), the processing ends.

As described above, according to the present embodiment, in the inspection apparatus that can perform the plurality of inspection functions of detecting different types of defects, control is performed so as to enable the user to select whether to automatically turn on the other inspection function, which makes it possible to easily cope with the failure.

### Third Embodiment

In the second embodiment, among the related inspection results, use of the plurality of types of inspections is selected using the checkboxes illustrated in FIG. 9, and priority in each combination is fixed. On the other hand, notification contents may be switched based on priority set by the user. In a third embodiment, an example of control for switching notification contents based on priority set by the user is described. In the following, only differences from the first embodiment are described in detail.

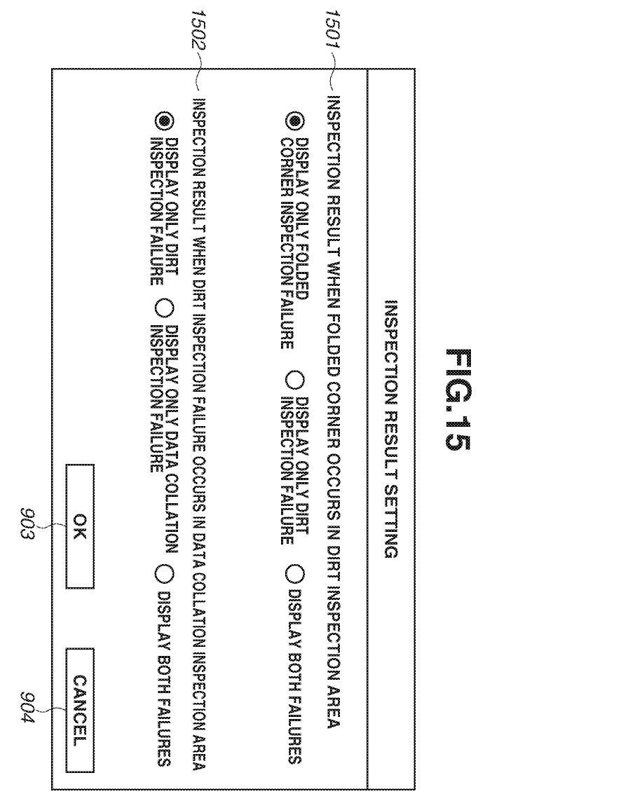

FIG. 15 is a schematic diagram of an inspection result setting screen according to the third embodiment. The inspection result setting screen is displayed on the display unit 241 by the CPU 238 of the inspection apparatus 109 in response to pressing operation of the button 811 by the user, and receives inspection setting operation by the user through the operation unit 242.

A UI 1501 for setting the inspection result when a folded corner occurs in the dirt inspection area is illustrated in FIG. 15. Display of only a folded corner inspection failure, display of only a dirt inspection failure, or display of both inspection failures is selected using a radio button. In a case where the dirt inspection failure and the folded corner inspection failure are notified in the processing of notification of the inspection result in step S406, setting selected in the UI 1501 is referred to, and notification is performed based on the setting.

A UI 1502 for setting the inspection result when a dirt inspection failure occurs in the data inspection target area is illustrated in FIG. 15. Display of only a dirt inspection failure, display of only a data collation failure, or display of both inspection failures is selected using a radio button. In a case where the data collation inspection failure and the dirt inspection failure are notified in the processing of notification of the inspection result in step S406, setting selected in the UI 1502 is referred to, and notification is performed based on the setting.

As described above, according to the present embodiment, in the inspection apparatus that can perform the plurality of inspection functions of detecting different types of defects, control is performed so as to switch the notification contents based on priority set by the user, which makes it possible to easily cope with the failure.

### Fourth Embodiment

In the first embodiment, the example in which, after processing of each of the plurality of types of inspection is completed, the related inspection result is determined, and the processing of notification of the inspection result is switched is described. In the fourth embodiment, an example in which control is performed such that the inspection is sequentially performed, and processing contents of an inspection subsequently performed are switched to prevent an inspection failure for the same defect from being notified a plurality of times is described. In the present embodiment, an example in which control is performed such that a folded corner is detected in the folded corner inspection but is not detected in the dirt inspection, and dirt is detected in the dirt inspection but is not determined to be a failure in the data collation inspection is described.

In the following, only differences from the first embodiment are described in detail.

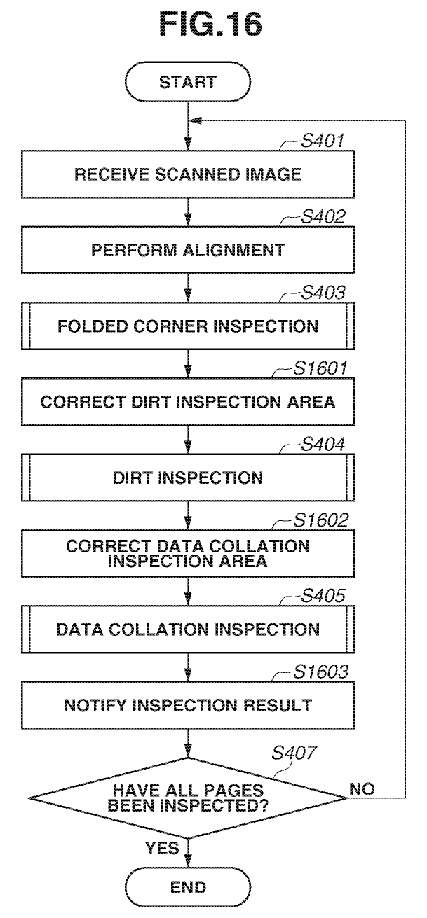

FIG. 16 is a flowchart illustrating a flow of processing performed by the inspection apparatus 109 when the inspection processing is performed according to the fourth embodiment. The processing illustrated in FIG. 16 is performed by the CPU 238 of the inspection apparatus 109.

In step S1601, the inspection apparatus 109 corrects the dirt inspection area based on the result of the folded corner inspection performed in step S403. The inspection apparatus 109 refers to the result of the folded corner inspection stored in the memory 239 of the inspection apparatus 109, and calculates the coordinates of the folded corner from the coordinates of the corner determined to be folded and the size of the folded corner. Thereafter, the inspection apparatus 109 changes a range of the dirt inspection area so as to exclude the coordinates of the folded corner from the dirt inspection area. As a result, in the dirt inspection performed in next step S404, the folded corner is not determined to be a dirt inspection failure.

In step S1602, the inspection apparatus 109 corrects the data inspection target area based on the result of the dirt inspection performed in step S404. The inspection apparatus 109 refers to the result of the dirt inspection stored in the memory 239 of the inspection apparatus 109, and acquires the coordinates determined to have dirt. Thereafter, the inspection apparatus 109 changes a range of the data inspection target area so as to exclude the coordinates of the dirt from the data inspection target area. As a result, in the data collation inspection performed in next step S405, the OCR processing or the bar code recognition processing described in step S702 is not performed on the dirt.

In step S1603, the inspection apparatus 109 displays the inspection results obtained in steps S403 to S405 on the display unit 241 to notify the user of the inspection results.

As described above, according to the present embodiment, in the inspection apparatus that can perform the plurality of inspection functions of detecting different types of defects, it is possible to easily cope with the failure. In the present embodiment, the control is performed such that the inspection area is corrected to prevent the inspection failure for the same defect from being notified a plurality of times; however, the control may be performed by another method, for example, by masking an area where a defect has been already detected in the scanned image to be inspected.

### Other Embodiments

Although various examples and embodiments of the present disclosure are described above, the spirit and the scope of the present disclosure are not limited to the spirit and the scope specifically described in the present specification.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034135, filed Mar. 4, 2025, which is hereby incorporated by reference herein in its entirety.

What is claimed is:

1. An inspection system reading a printed matter to generate read image data and inspecting the read image data, the inspection system comprising:
at least one memory and at least one processor configured to function as:
an inspection unit configured to perform a plurality of types of inspection;
a setting unit configured to receive, from a user, inspection setting for selecting inspection to be performed among the plurality of types of inspection; and
a specification unit configured to specify a failure factor based on an inspection result by the inspection unit,
wherein the inspection unit performs the plurality of types of inspection irrespective of the inspection setting selected by the user through the setting unit, and
wherein the specification unit specifies the failure factor based on inspection results of the plurality of types of inspection.

2. The inspection system according to claim 1, wherein the specification unit specifies the failure factor by analyzing presence/absence of interference in the inspection results of the plurality of types of inspection, and notifies the user of the failure factor.

3. The inspection system according to claim 1, further comprising a display unit,
wherein the setting unit receives, from the user, the inspection setting for selecting inspection, the inspection result of which is to be notified, and
wherein the display unit notifies the user of only an inspection result of the inspection selected in the inspection setting.

4. The inspection system according to claim 3, wherein the inspection unit performs the plurality of types of inspection on the read image data, and the user is not notified of a result of inspection not selected through the setting unit.

5. The inspection system according to claim 4, wherein the specification unit analyzes the inspection results of the plurality of types of inspection, and specifies the failure factor based on the inspection results of the plurality of types of inspection.

6. The inspection system according to claim 5,
wherein the display unit includes a display screen for providing information about the failure factor to the user, and
wherein the display screen displays a type of a failure and a corresponding factor.

7. The inspection system according to claim 6,
wherein the setting unit further includes a unit configured to set priority of each inspection when the user sets execution/non-execution of the inspection, and
wherein the specification unit specifies the failure factor based on the priority.

8. The inspection system according to claim 1, wherein the inspection unit changes an execution order of the plurality of types of inspection based on setting by the user.

9. The inspection system according to claim 1, wherein the plurality of types of inspection includes dirt inspection for inspecting presence/absence of dirt on the printed matter by comparing a reference image and the read image data.

10. The inspection system according to claim 1, wherein the plurality of types of inspection includes data collation inspection for comparing data included in a data inspection target area out of the read image data, with collation data.

11. The inspection system according to claim 1, wherein the plurality of types of inspection includes folded corner inspection for inspecting presence/absence of a folded corner of the printed matter by comparing a reference image and the read image data.

12. The inspection system according to claim 1, further comprising:
a reading unit configured to read the printed matter to generate the read image data;
an image forming unit configured to form an image on a sheet; and
a conveyance unit configured to convey the sheet on which the image is formed by the image forming unit,
wherein the reading unit reads the image on the sheet conveyed by the conveyance unit.
